(19) United States
(12) Patent Application Publication
(10) Pub. No.: US 2014/0295309 A1
(43) Pub. Date: Oct. 2, 2014

(54) FUEL CELL SYSTEM AND OPERATION METHOD THEREOF

(71) Applicants: SNU R&DB FOUNDATION, Seoul (KR); Hyundai Motor Company, Seoul (KR)

(72) Inventors: Nam Woo LEE, Hwasung-si (KR); Min Soo KIM, Seoul (KR)

(73) Assignees: SNU R&DB FOUNDATION, Seoul (KR); HYUNDAI MOTOR COMPANY, Seoul (KR)

(21) Appl. No.: 14/144,242

(22) Filed: Dec. 30, 2013

(30) Foreign Application Priority Data
Mar. 26, 2013 (KR) 10-2013-0032332

(51) Int. Cl. H01M 8/04

(52) U.S. Cl. CPC H01M 8/04298; H01M 8/04201; H01M 8/04753; H01M 8/0432
USPC 429/442; 429/457

(57) ABSTRACT

A fuel cell system includes a stack constituted by a set of fuel cells. An air supplier supplies air to an air electrode of the fuel cell and a hydrogen supplier supplies hydrogen to a fuel electrode of the fuel cell. A connector connects an air supply route for supplying the air to the air electrode from the air supplier and a hydrogen supply route for supplying the hydrogen to the fuel electrode from the hydrogen supplier. The hydrogen is supplied to the air electrode through the connector when the stack operates at a low temperature, which is equal to or lower than an optimal operating temperature.

### CROSS-REFERENCE TO RELATED APPLICATION

This application claims the benefit of priority to Korean Patent Application No. 10-2013-0032332 filed in the Korean Intellectual Property Office on Mar. 26, 2013, the entire contents of which are incorporated herein by reference.

### TECHNICAL FIELD

The present disclosure relates to a fuel cell system, and more particularly, to a fuel cell system and an operation method thereof that can solve a flooding problem of a fuel cell.

### BACKGROUND

As known, a fuel cell system uses an electric generator to receive hydrogen as fuel and oxygen in air and generate electrical energy by an electrochemical reaction of hydrogen and oxygen by a fuel cell.

For example, when the fuel cell system is applied to a fuel cell vehicle, it actuates an electric motor with the electrical energy produced by the fuel cell to drive a vehicle.

The fuel cell system includes a stack which is a set of fuel cells constituted by an air electrode and a fuel electrode, an air supplier supplying air to the air electrode, and a hydrogen supplier supplying hydrogen to the fuel electrode.

The fuel cell system further includes a hydrogen recirculator that recirculates hydrogen discharged from the fuel electrode to the fuel electrode.

A stack operates at a temperature equal to or lower than an optimal operating temperature (approximately 65 to 80° C.) in an initial driving. Accordingly, a large amount of condensed water remains in the fuel cell and causes flooding.

The condensed water remains in a gas diffusion layer (GDL) of the fuel cell, and since a characteristic of the gas diffusion layer is changed while a water repellency material of the gas diffusion layer is peeled off when the stack is used for a long time, it is not easy to remove the condensed water.

A general method for removing the condensed water that remained in the fuel cell includes supplying compressed air into the fuel cell. However, the condensed water in the GDL cannot be effectively removed by such method, and power may be lost with the compressed air supplied.

The above information disclosed in this Background section is only for enhancement of understanding of the background of the disclosure, and therefore, it may contain information that does not form the prior art that is already known in this country to a person of ordinary skill in the art.

### SUMMARY

The present disclosure provides a fuel cell system and an operation method thereof having advantages of directly removing condensed water remained in a fuel cell by injecting hydrogen into an air electrode when a stack operates at a low temperature before reaching an optimal operating temperature. In addition, the present disclosure provides a fuel cell system and an operation method of removing condensed water remained in a fuel cell when the fuel cell is off so as to improve cold start performance.

According to an exemplary embodiment of the present disclosure, a fuel cell system includes a stack constituted by a set of fuel cells. An air supplier supplies air to an air electrode of a fuel cell, and a hydrogen supplier supplies hydrogen to a fuel electrode of the fuel cell. A connector connects an air supply route for supplying the air to the air electrode from the air supplier and a hydrogen supply route for supplying hydrogen to the fuel electrode from the hydrogen supplier. The hydrogen may be supplied to the air electrode through the connector when the stack operates at a low temperature which is equal to or lower than an optimal operating temperature.

The connector may include a connection line connecting the air supply route and the hydrogen supply route.

At least one solenoid valve may be installed on the connection line.

According to another exemplary embodiment of the present disclosure, a fuel cell system includes a stack constituted by a set of fuel cells. An air supplier supplies air to an air electrode of a fuel cell, and a hydrogen supplier supplies hydrogen to a fuel electrode of the fuel cell and recirculates discharged hydrogen discharged from the fuel electrode to the fuel electrode. A connector connects an air supply route for supplying the air to the air electrode from the air supplier and a hydrogen discharge route for supplying the discharged hydrogen to the hydrogen supplier. The discharged hydrogen may be supplied to the air electrode through the connector when the stack is operated at a low temperature which is equal to or lower than an optimal operating temperature.

The optimal operating temperature of the stack may be 65 to 80° C., and the low-temperature operation temperature of the stack may be 10 to 40° C.

The connector may include a connection line connecting the air supply route and the hydrogen discharge route.

At least one solenoid valve may be installed on the connection line.

The connection line may include a purge line that purges the hydrogen in the fuel cell.

According to another exemplary embodiment of the present disclosure, an operation method of a fuel cell system includes sensing an operation temperature of a stack, and determining whether the operation temperature of the stack is equal to or lower than a predetermined optimal operating temperature. Hydrogen is supplied to a fuel electrode of the fuel cell or discharged from the fuel electrode to an air electrode of the fuel cell through a connection line when it is determined that the operation temperature is equal to or lower than the predetermined optimal operating temperature.

The hydrogen may be supplied to the air electrode through the connection line connecting an air supply route for supplying air to the air electrode from an air supplier and a hydrogen supply route for supplying the hydrogen to the fuel electrode from a hydrogen supplier.

The discharged hydrogen is supplied to the air electrode through the connection line connecting the air supply route for supplying the air to the air electrode from the air supplier and a hydrogen discharge line for supplying the hydrogen discharged from the fuel electrode to the hydrogen supplier

In the operation method, the amount of the hydrogen supplied to the air electrode may be controlled through a solenoid valve installed on the connection line. The predetermined optimal operating temperature of the stack may be 65 to 80° C.

### BRIEF DESCRIPTION OF THE DRAWINGS

FIG. 1 is a block diagram schematically illustrating a fuel cell system according to an exemplary embodiment of the present disclosure.

FIG. 2 is a flowchart for describing an operation method of a fuel cell system according to an exemplary embodiment of the present disclosure.

FIG. 3 is a graph for describing an action effect of a fuel cell system according to an exemplary embodiment of the present disclosure.

FIG. 4 is a block diagram schematically illustrating a fuel cell system according to another exemplary embodiment of the present disclosure.

### DETAILED DESCRIPTION OF THE EMBODIMENTS

An exemplary embodiment of the present disclosure will hereinafter be described in detail with reference to the accompanying drawings.

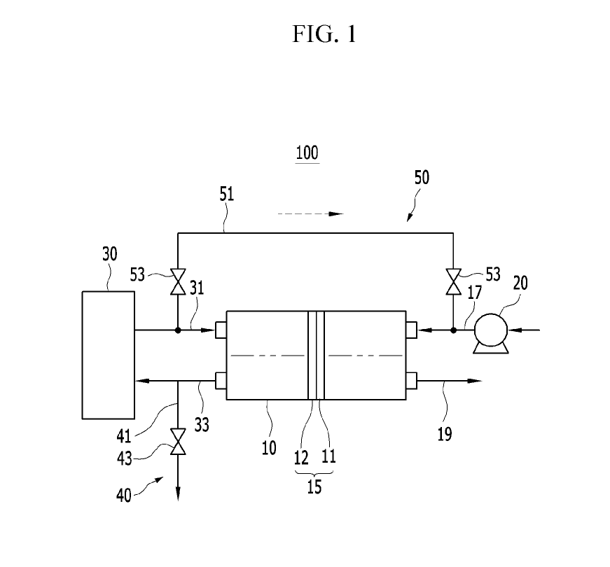

FIG. 1 a block diagram schematically illustrating a fuel cell system according to an exemplary embodiment of the present disclosure.

Referring to FIG. 1, a fuel cell system 100 according to an exemplary embodiment of the present disclosure as an electric generator that produces electrical energy by an electrochemical reaction of fuel, and oxidant may be applied to a fuel cell vehicle that drives an electric motor by using the electrical energy. Hereinafter, the fuel used in the fuel cell system 100 is defined as hydrogen, and the oxidant is defined as air.

The fuel cell system 100 according to an exemplary embodiment of the present disclosure basically includes a stack 10, an air supplier 20, and a hydrogen supplier 30.

The stack 10 is a set of fuel cells 15 constituted by a fuel electrode 12 receiving fuel and an air electrode 11 including a catalyst layer and a gas diffusion layer (GDL). The stack 10 receives hydrogen from the hydrogen supplier 30 and receives air from the air supplier 20, and generates electrical energy by an electrochemical reaction of oxygen of the air electrode 11 and hydrogen of the fuel electrode 12.

The air supplier 20 may include an air blower that receives power to drive and supplies the atmosphere air to the air electrode 11 of the fuel cells 15. In this case, the air supplier 20 and the air electrode 11 may be connected through an air supply route 17 so as to supply the air to the air electrode 11 from the air supplier 20.

The hydrogen supplier 30 may include a hydrogen tank (not illustrated) that compresses and stores hydrogen in a gas form and supplies the hydrogen to the fuel electrode 12 of the fuel cells 15. Herein, the hydrogen supplier 30 may recirculate hydrogen discharged from the fuel electrode 12 of the fuel cells 15 to the fuel electrode 12.

The hydrogen supplier 30 may include a mixing tank and a recirculation blower (not illustrated) that mix the hydrogen discharged from the fuel electrode 12 and the hydrogen supplied from the hydrogen tank and may supply the mixed hydrogen to the fuel electrode 12.

Hereinafter, the hydrogen supplied to the fuel electrode 12 through the hydrogen supplier 30 is referred to as “supplied hydrogen” and the hydrogen discharged from the fuel electrode 12 is referred to as “discharged hydrogen”.

A hydrogen inlet of the fuel electrode 12 may be connected with the hydrogen supplier 30 through a hydrogen supply route 31, and a hydrogen outlet of the fuel electrode 12 may be connected with the hydrogen supplier 30 through a hydrogen discharge route 33.

That is, the hydrogen supply route 31 supplies the supplied hydrogen to the fuel electrode 12, and the hydrogen discharge route 33 supplies the discharged hydrogen to the hydrogen supplier 30.

The fuel cell system 100 may further include a hydrogen purger 40 for purging the fuel electrode 12 in order to discharge water (condensed water) accumulated in the fuel electrode 12.

The hydrogen purger 40 may include a hydrogen purge line 41 connected to the hydrogen discharge route 33 and a purge valve 43 installed on the hydrogen purge line 41.

Since a hydrogen recirculation structure of the hydrogen supplier 30 and a configuration of the hydrogen purger 40 are known art which has been widely known to the art, a more detailed description of the configuration in the specification will be omitted.

In the fuel cell system 100, since the stack 10 operates under a low-temperature which is equal to or lower than an optimal operating temperature in an initial operation stage, a large amount of condensed water remains in the fuel cells 15 and may cause flooding.

The optimal operating temperature condition of the stack 10 may be between 65 and 80° C., and the low-temperature of the stack 10 may be between 10 and 40° C.

In the fuel cell system 100 according to an exemplary embodiment of the present disclosure, a small amount of hydrogen injected into the air electrode 11 directly removes the condensed water remained in the fuel cells 15 when the stack 10 operates at the low temperature before reaching the optimal operating temperature. Further, in the fuel cell system 100 according to an exemplary embodiment of the present disclosure, the small amount of hydrogen injected into the air electrode 11 directly removes the condensed water that remains in the fuel cells 15 when the fuel cell 15 is off after the operation of the fuel cell 15 is finished

That is, the fuel cell system 100 according to an exemplary embodiment of the present disclosure may phase-change the condensed water into vapor by using heat generated from an electrochemical reaction of hydrogen and oxygen by injecting a small amount of hydrogen to the air electrode 11 of the fuel cells 15 in order to prevent the fuel cells 15 from the flooding problem under the low-temperature operation condition of the stack 10 or the fuel cell 15 off condition.

The fuel cell system 100 according to an exemplary embodiment of the present disclosure, a connector 50 supplies the supplied hydrogen to the air electrode 11 of the fuel cell 15 under or the fuel cell 15 off condition or the low-temperature operation condition when the temperature is equal to or lower than the optimal operating temperature of the stack 10.

The connector 50 may include a connection line 51 that connects the air supply route 17 and the hydrogen supply route 31.

The connection line 51 supplies some of the supplied hydrogen supplied to the fuel electrode 12 of the fuel cells 15 to the air electrode 11 of the fuel cells 15 from the hydrogen supplier 30 through the hydrogen supply route 31 under the low-temperature operation condition. In addition, the connection line 51 supplies the small amount of the supplied hydrogen to the air electrode 11 of the fuel cells 15 under the fuel cell 15 off condition.

That is, some of the supplied hydrogen supplied to the fuel electrode 12 of the fuel cells 15 from the hydrogen supplier 30 through the hydrogen supply route 31 may be supplied to the air supply route 17 through the connection line 51, and supplied to the air electrode 11 of the fuel cells 15 through the air supply route 17 together with air.

At least one solenoid valve 53 that selectively opens and closes a passage of the connection line 51 by a controller (not illustrated) is installed on the connection line 51. For example, the solenoid valve 53 may be installed at each of the air supply route 17 and the hydrogen supply route 31 on the connection line 51.

Herein, the amount of the supplied hydrogen supplied to the air electrode 11 of the fuel cells 15 through the connection line 51 may be controlled by controlling an opening/closing cycle of the solenoid valve 53 using the controller.

Since the amount of the supplied hydrogen may depend on an operation temperature of the stack 10, and the like, the amount is not limited to a predetermined value in an exemplary embodiment of the present disclosure.

Hereinafter, a working and operation method of the fuel cell system 100 according to an exemplary embodiment of the present disclosure will be described in detail with reference to the accompanying drawings.

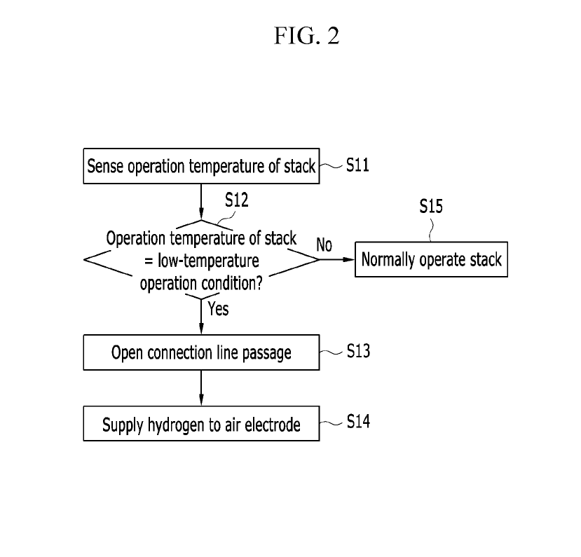

FIG. 2 is a flowchart for describing an operation method of a fuel cell system according to an exemplary embodiment of the present disclosure.

Referring to FIGS. 1 and 2, in an exemplary embodiment of the present disclosure, when the fuel cell system 100 is initially operated, air supplied from the air supplier 20 is supplied to the air electrode 11 of the fuel cells 15 through the air supply route 17

Simultaneously, the hydrogen supplier 30 supplies hydrogen supplied from the hydrogen tank (not illustrated) to the fuel electrode 12 of the fuel cells 15 through the hydrogen supply route 31. The electrical energy is generated through the electrochemical reaction of hydrogen and oxygen in the fuel cells 15, the hydrogen (discharged hydrogen) that reacts and remains is discharged from the fuel electrode 12, and the discharged hydrogen is supplied to the hydrogen supplier 30 through the hydrogen discharge route 33.

Therefore, the hydrogen supplier 30 mixes the discharged hydrogen discharged from the fuel electrode 12 and the hydrogen (supplied hydrogen) supplied from the hydrogen tank and supplies the supplied hydrogen to the fuel electrode 12 of the fuel cells 15 through the hydrogen supply route 31.

Herein, air that reacts and remains in the air electrode 11 of the fuel cells 15 and water generated by the electrochemical reaction of hydrogen and oxygen may be discharged through the air discharge line 19. The operation temperature of the stack 10 rises by heat generated from the electrochemical reaction of hydrogen and oxygen.

When the fuel cell system 100 initially operates, a temperature sensor (not illustrated) senses the operation temperature of the stack 10 (S11), and a signal for the sensed temperature is transferred to the controller.

Then, the controller determines whether the stack 10 is under a low-temperature which is equal to or lower than a predetermined optimal operating temperature (S12). In this case, the optimal operating temperature is between 65 and 80° C., and the low-temperature of the stack 10 is between 10 and 40° C. In step S12, when it is determined that the stack 10 operates under the low-temperature which is equal to or lower than the predetermined optimal operating temperature, a large amount of condensed water remains in the fuel cells 15 and causes flooding. As a result, the controller applies an electrical signal to the solenoid valve 53 of the connection line 51 and opens the passage of the connection line 51 (S13).

Accordingly, some of the supplied hydrogen supplied to the fuel electrode 12 of the fuel cells 15 from the hydrogen supplier 30 through the hydrogen supply route 31 is supplied to the air supply route 17 through the connection line 51, and the hydrogen supplied to the air supply route 17 is supplied to the air electrode 11 of the fuel cells 15 through the air supply route 17 together with the air (S14).

Herein, the amount of the supplied hydrogen supplied to the air electrode 11 of the fuel cells 15 through the connection line 51 may be controlled by controlling the opening/closing cycle of the solenoid valve 53 using the controller. Accordingly, the heat generated from the fuel cells 15 may be maximized by supplying a small amount of hydrogen to the air electrode 11 of the fuel cells 15 under the low-temperature operation condition of the stack 10.

That is, the heat is generated by from the fuel cells 15 by the electrochemical reaction of hydrogen and oxygen, and the heat may be removed by phase-changing the condensed water remained in the fuel cells 15 (S15).

The heat generated through the electrochemical reaction of the small amount of hydrogen and oxygen supplied to the air electrode 11 through the connection line 51 phase-changes the condensed water generated by the electrochemical reaction of the small amount of hydrogen and oxygen and the condensed water remained in the fuel cells 15 into vapor.

When the small amount of hydrogen is supplied to the air electrode 11 through the connection line 51, voltage of the stack 10 decreases, and as the voltage decreases, additional heat is generated from the fuel cells 15.

Further, vapor pressure in a catalyst layer of the fuel cells 15 becomes higher than vapor pressure in a flowing route of a separator (not illustrated) for making reacted gas to flow due to the aforementioned heat.

The vapor pressure in the catalyst layer is used to push a water drop remained in the gas diffusion layer (GDL) to the flowing route of a separate (not illustrated) to smoothly discharge condensed water in the gas diffusion layer to the outside.

On the other hand, such a method of injecting the small amount of hydrogen into the air electrode 11 of the fuel cells 15 may be used as a method for rapidly raising the temperature of the stack 10 at the time of cold-starting the stack 10.

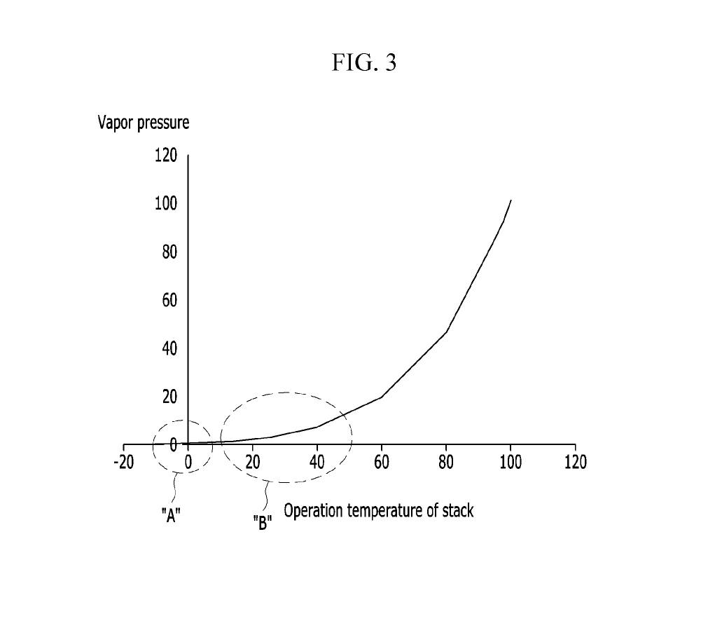

However, in this case, the heat is generated by decreasing the voltage, and when the temperature of the stack 10 rises in some degree, injection of hydrogen into the air electrode 11 is stopped. As a result, the vapor pressure in the catalyst layer does not significantly change even though the temperature of the stack 10 rises as illustrated in region “A” of FIG. 3.

That is, in the method of injecting the small amount of hydrogen into the air electrode 11 of the fuel cells 15 at the time of cold-starting the stack 10, since the vapor pressure in the catalyst layer is not almost increased, it is impossible to remove the water remained in the gas diffusion layer (GDL).

As illustrated in region “B” of FIG. 3 according to an exemplary embodiment of the present disclosure, since the vapor pressure in the catalyst layer rapidly increases as the temperature of the stack 10 by injecting the small amount of hydrogen into the air electrode 11 of the fuel cells 15 under the low-temperature operation condition (10 to 40° C.) just after starting the stack 10 at room temperature, the water remained in the gas diffusion layer (GDL) may be removed by the aforementioned action.

While the water remained in the fuel cells 15 is removed by injecting the small amount of hydrogen into the air electrode 11 of the fuel cells 15 under the low-temperature operation condition of the stack 10 as described above in detail, when it is determined that an operation temperature of the stack 10 exceeds the low-temperature operation condition through the controller, the passage of the connection line 51 is closed by actuating the solenoid valve 53 through the controller in an exemplary embodiment of the present disclosure. Then, the stack 10 receives the air from the air supplier 20 and receives the supplied hydrogen from the hydrogen supplier 30 to generate electrical energy through the electrochemical reaction of hydrogen and oxygen (step S16).

In the fuel cell system 100 according to an exemplary embodiment of the present disclosure described up to now, the condensed water remained in the fuel cells 15 may be evaporated and removed using the heat generated through the electrochemical reaction of hydrogen and oxygen by injecting a small amount of hydrogen into the air electrode 11 of the fuel cells 15 under the low-temperature (10 to 40° C.) just after starting the stack 10 at room temperature

Further, the water remained in the gas diffusion layer may be effectively removed by increasing the vapor pressure in the catalyst layer of the fuel cells with the heat generated through the electrochemical reaction of hydrogen and oxygen, in an exemplary embodiment of the present disclosure.

Therefore, the water remained in the fuel cells 15 may be directly removed by injecting the small amount of hydrogen into the air electrode 11 in an exemplary embodiment unlike the related art that supercharges the inside of the fuel cells 15 with air, thus preventing the fuel cells 15 from the flooding problem and reducing power consumption caused while supercharging of air. The method for removing the condensed water remained in the fuel cell 15 under the low-temperature operation condition, which is equal to or lower than the optimal operating temperature of the stack 10, is described. The controller may further determine whether the fuel cell 15 is off, and a temperature of the stack 10 is a set temperature in step S12 so that the controller determines whether the stack 10 is under the low-temperature operation condition which is equal to or lower than a predetermined optimal operating temperature. The set temperature of the stack 10 may be about 65° C., and may be predetermined by a person of ordinary skill in the art. The controller opens the passage of the connection line 51 (S13) if it is determined that the stack 10 has the set temperature under the fuel cell 15 off condition. In addition, a small amount of hydrogen is supplied to the air supply route 17 through the connection line 51, and the following process is same as the above mentioned process. Therefore, the condensed water remained in the fuel cells 15 can be removed under the fuel cell 15 off condition, and the performance of removing the condensed water may be further improved. Ultimately, cold start performance can be improved.

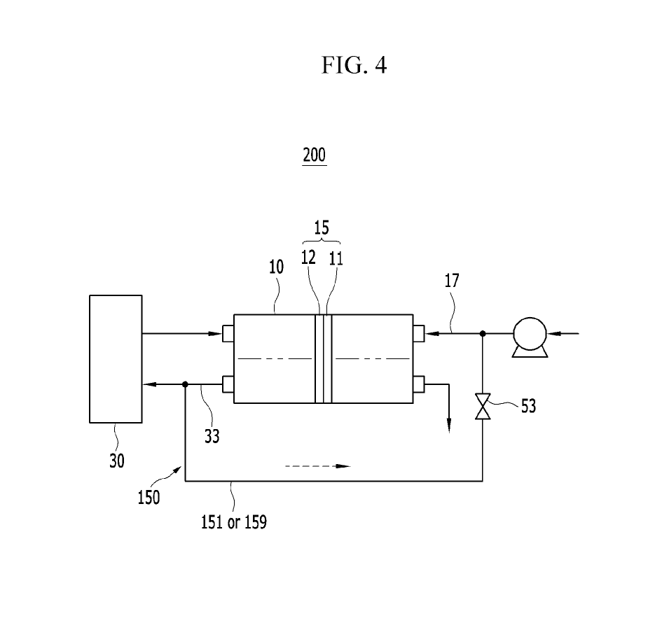

FIG. 4 is a block diagram schematically illustrating a fuel cell system according to another exemplary embodiment of the present disclosure.

Hereinafter, the same reference numerals refer to constituent elements that perform the same functions as the aforementioned constituent elements.

Referring to FIG. 4, a fuel cell system 200 according to another exemplary embodiment of the present disclosure has a structure of the aforementioned exemplary embodiment and may include a connection line 151 that connects the air supply route 17 and the hydrogen discharge route 33 as the connector 150.

The connection line 151 supplies some of the discharged hydrogen through the fuel electrode 12 of the fuel cells 15 to the air electrode 11 of the fuel cells 15 under the low-temperature operation condition which is equal to or lower than the optimal operation temperature of the stack 10.

That is, some of the discharged hydrogen, which is discharged from the fuel electrode 12 of the fuel cells 15 and supplied to the hydrogen supply unit 30 through the hydrogen discharge route 33, may be supplied to the air supply route 17 through the connection line 151 and to the air electrode 11 of the fuel cells 15 together with the air through the air supply route 17.

The solenoid valve 53 capable of selectively opening and closing the passage of the connection line 151 is installed on the connection line 151 by the controller (not illustrated). The amount of the discharged hydrogen supplied to the air electrode 11 of the fuel cells 15 through the connection line 151 may be controlled by controlling the opening/closing cycle of the solenoid valve 53 using the controller.

Since the supply amount of the discharged hydrogen may depend on the operation temperature of the stack 10 and the like, the supply amount is not limited to a predetermined value in an exemplary embodiment of the present disclosure.

Accordingly, some of the discharged hydrogen discharged from the fuel electrode 12 of the fuel cells 15 and supplied to the hydrogen supplier 30 through the hydrogen discharge route 33 may be supplied to the air electrode of the fuel cells 15 through the connection line 151 under the low-temperature operation condition which is equal to or lower than the optimal operating temperature of the stack 10 in an exemplary embodiment of the present disclosure.

The connection line 151 according to another exemplary embodiment of the present disclosure may include a hydrogen purge line 159 to purge the hydrogen in the fuel cells 15. That is, the connection line 151 purges the hydrogen in the fuel cells 15 by connecting the hydrogen purge line to the air supply route 17.

Since remaining components and working effects of the fuel cell system 200 according to another exemplary embodiment of the present disclosure are the same as those of the aforementioned exemplary embodiment, a detailed description thereof will be omitted.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A fuel cell system, comprising:
a stack constituted by a set of fuel cells;
an air supplier supplying air to an air electrode of a fuel cell;
a hydrogen supplier supplying hydrogen to a fuel electrode of the fuel cell; and
a connector connecting an air supply route for supplying air to the air electrode from the air supplier and a hydrogen supply route for supplying hydrogen to the fuel electrode from the hydrogen supplier,
wherein the hydrogen is supplied to the air electrode through the connector when the stack becomes to a set condition.

2. The fuel cell system of claim 1, wherein the connector includes a connection line connecting the air supply route and the hydrogen supply route.

3. The fuel cell system of claim 2, wherein at least one solenoid valve is installed on the connection line.

4. The fuel cell system of claim 1, wherein the set condition of the stack is when the stack operates at a low temperature, which is equal to or lower than an optimal operating temperature.

5. The fuel cell system of claim 4, wherein the optimal operating temperature of the stack is 65 to 80° C. and a temperature of the low temperature operation of the stack is 10 to 40° C.

6. The fuel cell system of claim 1, wherein the set condition of the stack is that a temperature of the stack reaches a set temperature when the fuel cell is off.

7. The fuel cell system of claim 6, wherein the set temperature is 65° C.

8. A fuel cell system, comprising:
a stack constituted by a set of fuel cells;
an air supplier supplying air to an air electrode of a fuel cell;
a hydrogen supplier supplying hydrogen to a fuel electrode of the fuel cell and recirculating hydrogen discharged from the fuel electrode to the fuel electrode; and
a connector connecting an air supply route for supplying the air to the air electrode from the air supplier and a hydrogen discharge route for supplying the discharged hydrogen to the hydrogen supplier,
wherein, the discharged hydrogen is supplied to the air electrode through the connector when the stack becomes to a set condition.

9. The fuel cell system of claim 8, wherein the set condition of the stack is that the stack operates at a low temperature, which is equal to or lower than an optimal operating temperature.

10. The fuel cell system of claim 9, wherein the optimal operating temperature of the stack is 65 to 80° C. and a temperature of the low temperature operation of the stack is 10 to 40° C.

11. The fuel cell system of claim 9, wherein the connector includes a connection line connecting the air supply route and the hydrogen discharge route.

12. The fuel cell system of claim 11, wherein at least one solenoid valve is installed on the connection line.

13. The fuel cell system of claim 11, wherein the connection line includes a purge line that purges the hydrogen in the fuel cell.

14. The fuel cell system of claim 8, wherein the set condition of the stack is that a temperature of the stack reaches a set temperature when the fuel cell is off.

15. An operation method of a fuel cell system, the method comprising:
sensing an operation temperature of a stack;
determining whether the operation temperature of the stack is equal to or lower than a predetermined optimal operating temperature; and
supplying hydrogen supplied to a fuel electrode of a fuel cell or discharged from the fuel electrode to an air electrode of the fuel cell through a connection line when it is determined that the operation temperature is equal to or lower than the predetermined optimal operating temperature.

16. The method of claim 15, wherein the hydrogen is supplied to the air electrode through the connection line connecting an air supply route for supplying air to the air electrode from an air supplier and a hydrogen supply route for supplying the hydrogen to the fuel electrode from a hydrogen supplier.

17. The method of claim 16, wherein the amount of the hydrogen supplied to the air electrode is controlled through a solenoid valve installed on the connection line.

18. The method of claim 15, wherein the discharged hydrogen is supplied to the air electrode through the connection line connecting the air supply route for supplying air to the air electrode from the air supplier and a hydrogen discharge line for supplying the discharged hydrogen discharged from the fuel electrode to the hydrogen supplier.

19. The method of claim 18, wherein the amount of the hydrogen supplied to the air electrode is controlled through a solenoid valve installed on the connection line.

20. The method of claim 15, wherein the predetermined optimal operating temperature of the stack is between 65 and 80° C.
